(19) United States
(12) Patent Application Publication
(10) Pub. No.: US 2004/0246649 A1
(43) Pub. Date: Dec. 9, 2004

(54) Flow control valve with magnetic field sensor

(75) Inventor: Matthew M. Besen, Andover, MA (US)

Correspondence Address: PROSKAUER ROSE LLP, ONE INTERNATIONAL PLACE 14TH FL, BOSTON, MA, 02110, US

(73) Assignee: MKS Instruments, Inc., Andover, MA

(21) Appl. No.: 10/453,472

(22) Filed: Jun. 3, 2003

(51) Int. Cl. H01H 47/00

(52) U.S. Cl. 361/170

(57) ABSTRACT

Solenoid devices that include magnetic field sensors and methods for operating the devices are described. A device includes a magnetic field generator that generates a magnetic flux that extends through a magnetic flux circuit member formed at least in part from a ferromagnetic material and defining a gap that is effectively free of any ferromagnetic material. A magnetic flux sensor is disposed to sense a portion of the magnetic flux that extends across the gap. A device can be implemented as a fluid flow control valve.

### FIELD OF THE INVENTION

The present invention relates generally to solenoid devices, and, in particular, to solenoid fluid flow control valves.

### BACKGROUND OF THE INVENTION

Control and measurement of flowing gases and liquids is important in many industrial manufacturing applications, such as in semiconductor fabrication, optical coating deposition, and flat panel display manufacturing. For example, these applications can require the introduction of precise quantities of fluids to form films having a desired thickness and composition. Mass flow controllers are commonly used for fluid flow control and/or measurement in support of process tools used for these applications.

A mass flow controller typically includes a solenoid valve that mediates fluid flow through a valve orifice. A common solenoid valve has an insulated coil that surrounds a plunger core and is encased in a housing. Application of a current to the coil can position the plunger core relative to or against an orifice in a valve seat to control a fluid flow rate. The core can be made, for example, from materials having high magnetic permeability, such as iron alloys. The resulting magnetic flux in the core creates a magnetic force on the plunger that works in opposition to a force applied by a spring component of the valve.

Fluid flow through the valve can be controlled by controlling the position of the plunger relative to the valve seat. In one mode of operation, the plunger position is selected by selecting a current applied to the coil. The electromagnetic force applied to the plunger varies with a change in current, so the core moves toward or away from the valve seat in response to the change in current. The position of the plunger is determined by a balance of the forces acting on the plunger, i.e., spring force, magnetic force, and fluid-related forces.

The control system of some flow metering devices relies on the assumption that a given electrical current input to a solenoid valve coil produces the correct force on the plunger and an associated flow setting. Metering valves, however, have mechanical and electrical tolerance errors that can limit accuracy or repeatability of flow rates obtained in response to a given electrical current input. This error often includes a bias component and a random component, both of which can vary with the applied current.

In particular, magnetic materials can exhibit remanent induction (i.e., residual magnetization at zero current), which can lead to hysteresis in the position of a plunger and, therefore, hysteresis in fluid flow as a function of applied current. Temperature effects on the permeability of magnetic materials can also reduce predictability in the response of a valve. Moreover, difficulty in using a solenoid current setting to set valve flow can limit the usable control range or dynamic range of a valve.

To compensate for variations in flow rate, flow control valves often include a control system that attempts to compensate for error. Compensation demands on the control system, however, can increase valve response time and decrease valve performance.

In response to these difficulties, some applications rely on a group of flow control valves to control fluid flow over a wide range of values; each valve in the group can provide a different range of flow control. This solution, however, increases the cost of flow control equipment.

### SUMMARY OF THE INVENTION

The invention features improved solenoid devices, such as solenoid valves and solenoid switches. In one aspect, the invention features apparatus and methods that can provide solenoid flow control valves having more accurate, reproducible, and/or stable control of fluid flow, as well as wider dynamic range. A valve according to principles of the invention includes a ferromagnetic member having one or more portions. The ferromagnetic member defines at least one gap effectively separating ferromagnetic material of the member. The gap and the ferromagnetic member define a magnetic flux circuit. A magnetic field sensor is positioned to detect a magnetic field that spans the gap of the circuit.

The gap is effectively free of any magnetic flux shunts, such as a ferromagnetic bridge, connecting ferromagnetic material separated by the gap. The magnetic field sensor is therefore able to effectively monitor the magnetic field that spans the gap. In other words, any shunt across the gap should have a limited effect on the magnetic flux that extends through the gap and is thus available to the sensor for detection.

The sensor can provide a direct measurement of the magnetic field strength in the magnetic circuit. The measurement can support an accurate and repeatable determination of the magnetic forces on a valve plunger. The measurement can be utilized in a feedback loop to obtain a magnetic field that corresponds to a desired magnetic field. Alternatively, the feedback loop can be implemented to provide a correction to a selected solenoid coil current valve. Thus, hysteresis and other factors that impair the speed and accuracy of valve flow control can be mitigated.

A valve implemented according to principles of the invention can be used, as part of a mass flow controller for example, with semiconductor fabrication tools, such as plasma processing, thin film deposition, and etching systems. The valve can control the flow of a variety of gases including, for example, fluorine, chlorine, bromine, hydrogen, nitrogen, oxygen, or other gasses used in semiconductor processing. A valve control unit can compare a preselected flow rate to a measured flow rate and adjust the sensed magnetic flux in the magnetic circuit to obtain correspondence between the preselected and measured flow rates.

Accordingly, in a first aspect, the invention features a solenoid device. The device can be, for example, a switch or a valve. The device includes a magnetic flux circuit member formed at least in part from a ferromagnetic material and defining a gap that is effectively free of any ferromagnetic material. The device also includes a magnetic flux sensor to sense a portion of the magnetic flux that extends across the gap, and includes a magnetic field generator, for example, a coil, to generate the magnetic flux.

The magnetic flux circuit member may include one or more portions, which may be spaced by one or more gaps. For example, the member may include a housing adjacent to a magnetic field generator and a plunger moveably mounted adjacent to the housing. The member may also include, for example, a backstop mounted in a direction of movement of the plunger. Two of the housing, the plunger, and the backstop are separated by a gap. The gap defines a boundary region that effectively separates ferromagnetic material on either side of the gap.

The gap is essentially free of ferromagnetic materials shunting the ferromagnetic member portions on either side of the gap. That is, there is preferably no magnetic flux shunt, i.e., no substantial magnetic flux pathway, connecting the two ferromagnetic portions that border the gap. The gap can be entirely free of ferromagnetic, but can include other materials to provide indirect physical communication between the two portions separated by the gap. Thus, any materials that span or bridge the gap are essentially free of ferromagnetic materials.

The device includes a magnetic flux sensor to sense a portion of the magnetic flux that extends across the gap. The sensor may be disposed fully or partially in the gap or near the gap. The gap can be symmetrically configured and of uniform width to promote a uniform magnetic flux in the gap. The magnetic flux sensor can be, for example, a Hall, a magnetoresistive, or a magnetostrictive type sensor.

The gap can include a material having a magnetic permeability that is lower than a magnetic permeability of the housing and lower than a magnetic permeability of the backstop. The material can be a gas, a liquid, and/or a solid. The sensor may have a magnetic permeability similar to that of material in the gap.

In a second aspect, the invention features a method for operating a solenoid device. The method includes comparing a measured flow rate of the valve to a preselected flow rate, sensing a portion of a magnetic flux in a magnetic flux circuit of the valve, and causing the sensed magnetic flux to change until the measured flow rate corresponds to the preselected flow rate.

### BRIEF DESCRIPTION OF THE DRAWINGS

This invention is described with particularity in the appended claims. The above and further advantages of this invention may be better understood by referring to the following description taken in conjunction with the accompanying drawings, in which:

FIG. 1a is a cross-sectional side view of an embodiment of a solenoid device.

FIG. 1b is a cross-sectional top view at plane 1b of the solenoid device of FIG. 1a.

FIG. 1c is a cross-sectional top view at plane 1c of the solenoid device of FIG. 1a.

FIG. 2a is a cross-sectional view of an embodiment of a solenoid device.

FIG. 2b is cross-sectional view at plane 2b of the solenoid device of FIG. 2a.

FIG. 2c is cross-sectional view at plane 2c of the solenoid device of FIG. 2a.

FIG. 3 is a flowchart of an embodiment of a method for operating a solenoid device.

FIG. 4 is a schematic diagram of an embodiment of a control circuit.

FIGS. 5a and 5b are graphs of fluid flow rate as a function respectively of applied coil current and measured magnetic field for a sample valve assembled according to principles of the invention.

### DETAILED DESCRIPTION

The word “hysteresis” herein refers to the lagging in the values of resulting magnetization in a magnetic material due to a changing magnetizing force.

The word “remanence” herein refers to the magnetic induction remaining in a magnetized substance no longer under external magnetic influence. For example, a ferromagnetic plunger of a solenoid may exhibit residual magnetization when no current is applied to the solenoid coil.

The word “reluctance” herein refers to the opposition offered in a magnetic circuit to magnetic flux, and may be defined as the ratio of the magnetic potential difference to the corresponding flux. The reluctance of a component in a magnetic flux circuit is analogous to the resistance of a component in an electrical current circuit.

“Ferromagnetic materials”, as used herein, refers to materials that concentrate magnetic flux by a factor of more than approximately 10 times. The relative permeability of ferromagnetic materials as a ratio to the permeability of a vacuum can be as high as approximately 1,000,000. Ferromagnetic materials include, for example, soft iron and some steel and nickel alloys. Preferred embodiments of the invention do not include permanent magnetic materials in a magnetic flux circuit.

The terms “magnetic field sensor” and “magnetic flux sensor” herein interchangeably refer to a sensor than can detect a magnetic field and can support measurement of characteristics of the field. For example, a sensor can support measurement of value of a field strength or flux density associated with the field.

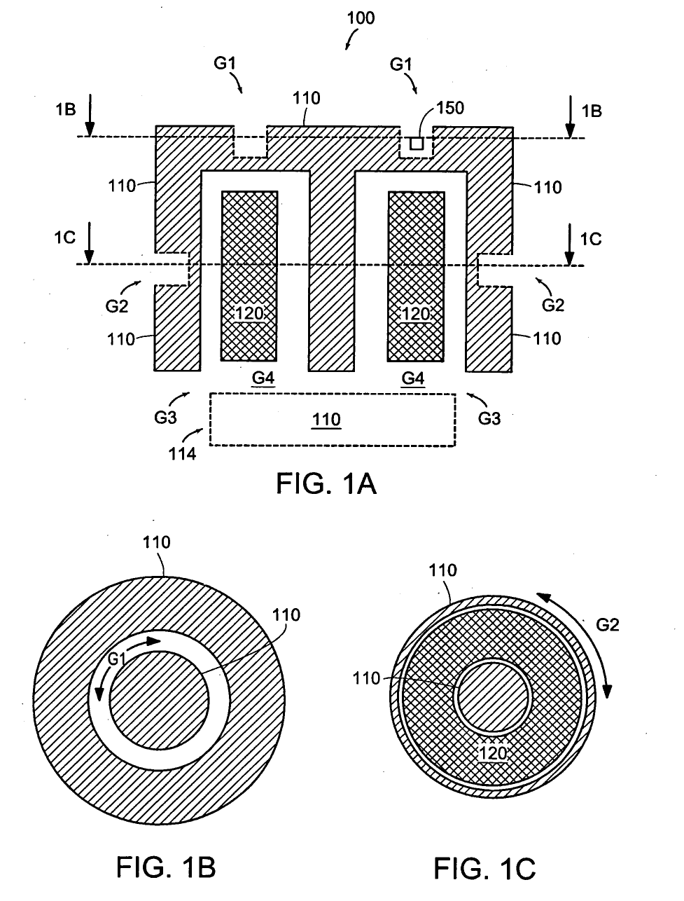

FIG. 1a illustrates a cross-sectional view of an embodiment of a solenoid device 100. The device 100 includes one or more ferromagnetic portions 110 of a magnetic flux circuit member, a magnetic field source 120, and at least one magnetic field sensor 150. As illustrated, the ferromagnetic portions 110 optionally include a plunger portion 114, which can be moveable relative to the other ferromagnetic portions 110. As illustrated, the plunger portion 114 is physically separated from the other ferromagnetic portions 110 of the circuit member. In alternative implementations of the device 100, the plunger portion 114 is attached to or an extension of one or more of the other ferromagnetic portions 110.

In alternative implementations of the device 100, one or more of the ferromagnetic portions 110 are moveable relative to the magnetic field source 120. For example, a ferromagnetic portion 110 can be fixedly disposed while the magnetic field source 120 is moveably disposed, or a ferromagnetic portion 110 can be moveably disposed while the magnetic field source 120 is fixedly disposed. As will be apparent to one having skill in the solenoid arts, the device 100 can be implemented as, for example, a flow control valve, a switch, or a voice coil.

The ferromagnetic portions 110 of the magnetic flux circuit member are formed from one or more ferromagnetic materials and define one or more gaps G1, G2, G3, G4. The magnetic field source 120 generates a magnetic flux in a magnetic flux circuit defined by the magnetic flux circuit member and the one or more gaps G1, G2, G3, G4, which act as reluctant components in the magnetic flux circuit.

One or more magnetic field sensors 150 are disposed to sense the magnetic flux extending through at least one of the gaps G1, G2, G3, G4. Preferably, the gap G1, G2, G3, G4 having an associated sensor 150 is completely or effectively free of any ferromagnetic material. A gap G1, G2, G3, G4 that is effectively free of any ferromagnetic material forces the magnetic flux to extend across the gap G1, G2, G3, G4 in a manner that permits a sensor 150 to effectively sense the magnetic flux.

A gap G1, G2, G3, G4 that is effectively free of any ferromagnetic material extending across the gap has insufficient ferromagnetic material to permit the magnetic flux to shunt the gap G1, G2, G3, G4. Thus, magnetic flux extending across the gap G1, G2, G3, G4 will, for example, substantially extend through portions of the gap G1, G2, G3, G4 having a relatively high reluctance, as provided, for example, by air or a vacuum. Moreover, a symmetrically shaped gap having a uniform gap separation is desirable to provide a uniform magnetic flux in the gap.

The device 100 can be operated by controlling the magnetic field sensed by the sensor 150. Hysteresis encountered in operation of the device can thus be less than that encountered in prior solenoid devices lacking the above-described features.

FIG. 1b is a cross-sectional top view of the solenoid device 100 through plane 1b as indicated in FIG. 1a. The gap G1 defines a boundary that separates neighboring ferromagnetic portions 110 of the magnetic flux circuit member. The gap G1 has a ring-shape and is spanned by a thin remaining portion of the ferromagnetic material that is insufficient to effectively shunt the gap G1. The gap G1 thus provides a component in the magnetic flux circuit having a relatively high reluctance.

FIG. 1c is a cross-sectional top view of the solenoid device 100 through plane 1c as indicated in FIG. 1a. The structural features of the gap G2 are similar to that of gap G1. Other gaps G3, G4, as illustrated, have no ferromagnetic material spanning them. As described above, any one or more of the gaps G1, G2, G3, G4, can have an associated magnetic field sensor 150 to monitor the magnetic flux in the magnetic flux circuit.

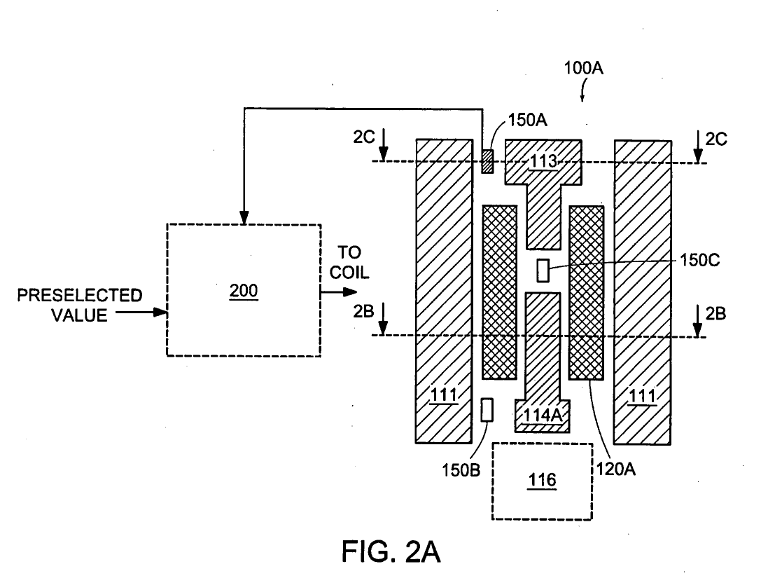

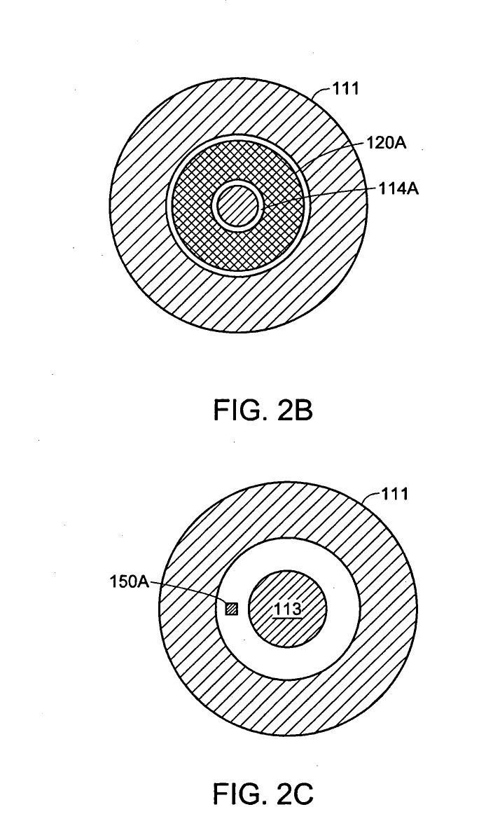

FIG. 2a illustrates a cross-sectional side view of an embodiment of a solenoid device 100A that incorporates features of the device illustrated in FIG. 1. The device 100A has a magnetic flux circuit member that includes a housing 111, a plunger 114A, and a backstop 113. The device 100A also includes a magnetic field source 120A and one or more magnetic field sensors 150A, 150B, 150C. The device 100A can include a control circuit 200. The plunger 114A can reside at least partially within a cavity defined by the housing 111. The plunger 114A can move along an axis defined by the housing 111.

The device 100A can be implemented as a valve. A valve can include a valve seat 116 disposed to a side of the plunger 114A opposite to the backstop 113. The valve seat 116 can include a fluid orifice. Cooperative interaction of the plunger 114A and the valve seat 116 can serve to control fluid flow through the valve.

FIG. 2b illustrates a cross-sectional top view of the solenoid device 100A, sectioned along plane 2b. FIG. 2c illustrates a cross-sectional top view of the solenoid device 10A, sectioned along plane 2c. A symmetrical ring-shaped gap having a uniform width separates the housing 111 and the backstop 114A. A symmetrical gap and/or a gap having a uniform width can improve the uniformity of the magnetic flux extending across the gap.

The magnetic field source 120A generates a magnetic field. The magnetic field source 120A can be mounted on, for example, the housing 111 and/or the backstop 113. The magnetic field source 120A can include a coil that induces a magnetic field when a current flows through the coil. The coil can extend beyond the plunger 114A in a direction toward or along the backstop 113 while the plunger 114A can extend in an opposite direction beyond the coil. As known to one having ordinary skill in the solenoid arts, the force exerted by the magnetic field on the plunger 114A can then pull the plunger 114A toward the coil, i.e., away from the valve seat 116. The relative positions of the plunger 114A and a coil can be altered so that, for example, the magnetic field caused by the source 120A will urge the plunger 114A toward the valve seat 116.

To counter the force on the plunger 114A arising from the magnetic field, the device 100 can include spring means, for example, one or more springs, to urge the plunger 114A out of the coil, for example, toward the valve seat 116. The counterbalanced forces on the plunger 114A, which arise from the spring means and the magnetic field, control the separation between the plunger 114A and the valve seat 116. When the plunger 114A contacts the valve seat 116, the combined action of the spring means and magnetic field controls the force applied to the valve seat 116.

The housing 111, the plunger 114A, and the backstop 113 define components of the magnetic flux circuit member through which a magnetic flux passes when induced by the magnetic field source 120A. The housing 111, the plunger 114A, and the backstop 113 are formed from materials that concentrate magnetic flux. Such materials include those that have a permeability greater than the surrounding environment of the flux circuit components. The surrounding environment can be, for example, air. The materials may thus be ferromagnetic materials.

Ferromagnetic materials have high magnetic permeabilities and thus are preferred for better confinement of the magnetic flux within the components of the magnetic flux circuit. Components of the magnetic flux circuit can include a single material or a combination of materials. The flux-concentrating material (e.g., a ferromagnetic material) increases the inductance of, for example, a coil far beyond that obtainable from an otherwise identical air-core coil. Ferromagnetic materials are preferred to obtain substantial concentration of magnetic flux.

One or more magnetic field sensors, such as the illustrated sensors 150A, 150B, 150C, can be disposed entirely in, partially in, or next to an associated gap. A sensor 150A, 150B, 150C need not reside entirely or partially in the gap so long as it can effectively detect the magnetic field that extends across the gap. A magnetic field sensor 150A, 150B, 150C can include, for example, a Hall, a magnetoresistive, or a magnetostrictive element. One or more sensors 150A, 150B, 150C permit monitoring of the magnetic flux in the magnetic flux circuit by detecting one or more values of the magnetic flux (for example, magnetic flux density) associated with one or more gaps. Sensors 150A, 150B, 150C thereby provide more accurate monitoring of the magnetic force applied to a plunger than provided, for example, by knowledge of a current applied to a solenoid coil.

Sensors can reside in alternative locations to detect the magnetic flux. For example, sensors can reside at any appropriate gap in the magnetic flux circuit defined by components of the device 100A. For example, as illustrated in FIG. 2a, a sensor 150B can reside in a gap between the housing 111 and the plunger 1114A or a sensor 150C can reside in a gap between the backstop 113 and the plunger 114A. Alternatively, the valve seat 116 can be part of the magnetic flux circuit and a sensor (not shown) can reside in a gap between the valve seat 116 and the housing 111. The device 100A can include more than one sensor, which can reside at one or more locations.

The gap with which the sensor is associated is preferably entirely free of ferromagnetic. That is, there is preferably no effective magnetic flux shunt, i.e., no easy magnetic flux pathway, connecting the two components that border the gap.

Provision of a gap that is essentially free of a magnetic flux shunt forces a significant portion of the magnetic flux to extend across the portion of the gap where the sensor 150A resides. The gap thus acts as a resistive component in the magnetic flux circuit. The sensor 150A can thus effectively detect the magnetic flux associated with the gap.

The housing 111 and the backstop 113, for example, are completely separated by an ring-shaped gap, which can be filled with air. The structures that define this gap are symmetrical, and the gap width is uniform to provide a substantially uniform magnetic field in the gap to aid accurate detection of the field.

The gap need not be free of all materials. For example, a solid, liquid, and/or gaseous material of effectively low permeability can be present in the gap. A solid material that bridges the gap can provide, for example, indirect mechanical communication between the housing 111 and the backstop 113 for mechanical support. As described above, the material of the mechanical support structure extending across the gap should be essentially free of ferromagnetic and paramagnetic portions.

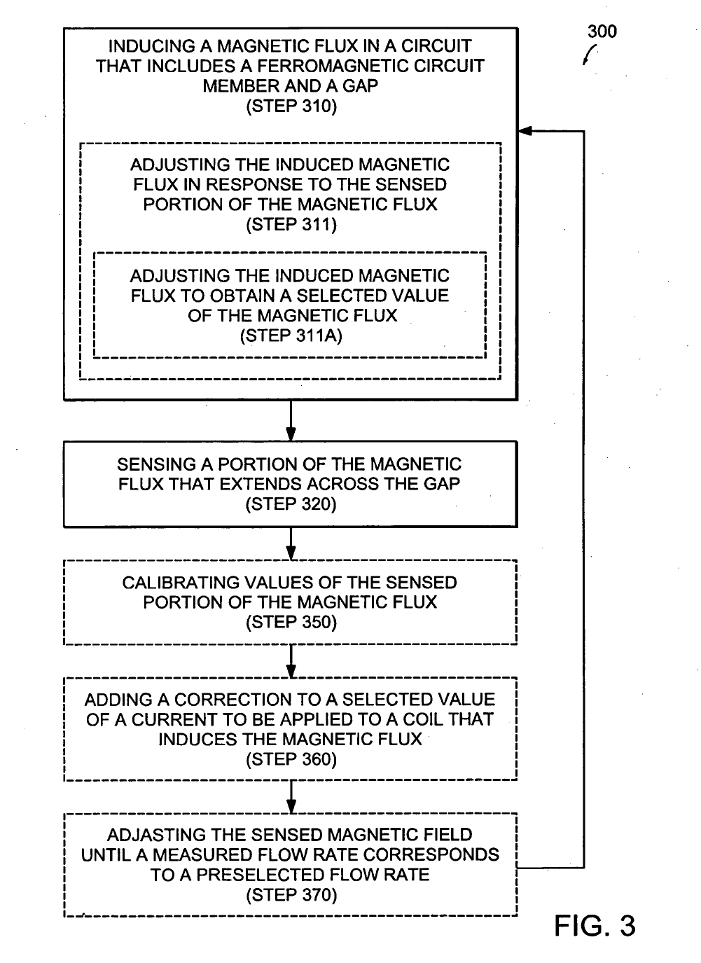

Now referring to FIG. 3, a solenoid device, according to principles of the invention, can be controlled by controlling a sensed magnetic flux rather than by conventional control of a coil current. FIG. 3 illustrates a flowchart of an embodiment of a method 300 for operating a solenoid device. The method can be implemented, for example, with the devices 100, 100A described above. The method 300 includes inducing a magnetic flux in a magnetic flux circuit that includes a gap and a magnetic flux circuit member (including, for example, a housing, a plunger, and/or a backstop) (STEP 310). The method 300 also includes sensing a portion of the magnetic flux that extends across the gap (STEP 320).

The step of inducing the magnetic flux (STEP 310) can include adjusting the induced magnetic flux in response to the sensed portion of the magnetic flux (STEP 311). The magnetic flux can be adjusted to obtain a selected value of the magnetic flux (STEP 311a). The value can be selected, for example, to obtain at least a selected one of a flow rate, a plunger position, a magnetic flux-based force applied to the plunger, and/or a force applied by the plunger to a valve seat.

The selected magnetic flux value can be obtained by comparing a measured device value to a preselected device value. The measured device value and the preselected device value respectively can be, for example, a measured flow rate value and a desired flow rate value. Thus, the selected magnetic flux value can be adjusted, for example, when the measured device value deviates from the preselected device value. Thus, in one implementation of the method 300, adjustment of the selected magnetic flux value can cease when the preselected and measured values have a desired correspondence (STEP 370).

The selected magnetic flux value may be provided to a power source in the form of a magnetic field set point. The power source controls delivery of power to a magnetic field generator in the valve to adjust the sensed magnetic flux to cause it to correspond to the magnetic field set point.

The method 300 can further include obtaining a calibration of values of the sensed magnetic flux versus values of a physical parameter of the solenoid device (STEP 350). The physical parameter can include, for example, a flow rate, an electromagnetic force applied to the plunger, and/or a pressure applied by the plunger to a valve seat. The selected magnetic flux can be selected via reference to the calibration values.

In some implementations of the method 300, a current is applied to a coil to induce the magnetic flux in the circuit, and a value of the applied current is selected to control a physical parameter of the circuit. The method 300 can then further include adding a correction to a selected value of a current to be applied to the coil to obtain an actual value of current to be applied to the coil in response to the sensed magnetic flux value (STEP 360). In this manner, for example, a current selected by a user can be adjusted to obtain a proper current for application to the coil. Thus, for example, the adjustment can compensate for hysteresis encountered in response to applied current.

The method 300 can thus include feedback features through which the sensed magnetic flux supports device control. The device 100 and the method 300 can thus both mitigate effects of hysteresis, and thus can provide more accurate and repeatable flow control, in particular, at low flow rates. These benefits can be obtained via either manual or automated operation of the device 100.

In a manual mode of operation, an operator of the device 100 can monitor readings from, for example, the sensor 150A. The operator can control a current applied to the source 120A to obtain a desired magnetic field reading or to obtain an appropriate correction to a selected applied current value to obtain a desired response, for example, a desired flow rate. Several alternative modes of operation will be apparent to one having ordinary skill in the solenoid device arts. For example, an operator can refer to a calibration table that relates plunger pressure or fluid flow rate to magnetic field flux, and adjust a magnetic field generator until the desired magnetic flux value is obtained.

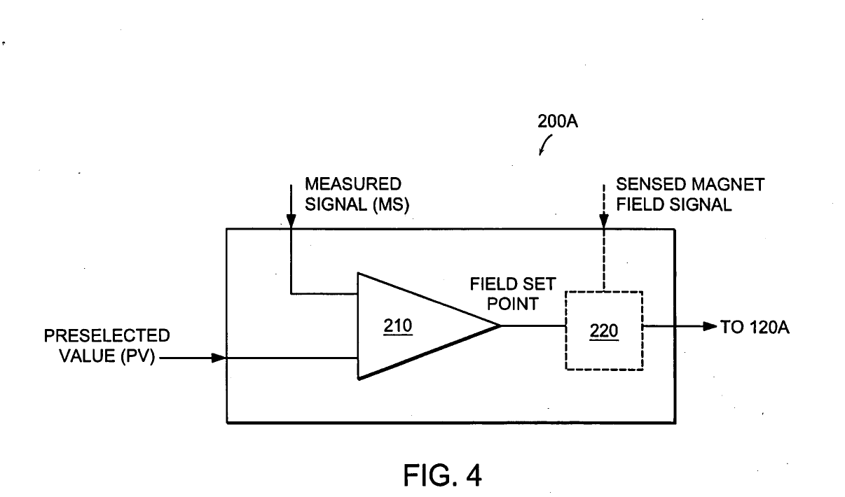

Alternatively, the control circuit 200 can automate, at least in part, control functions for the device 100A. FIG. 4 illustrates a schematic diagram of an embodiment of a control circuit 200A. The control circuit 200A can provide control for the device 100 illustrated in FIG. 1a, or can serve as the control circuit 200 of the device 100A illustrated in FIG. 2a. The control circuit 200A includes an operational amplifier 210 that receives a measured signal MS and a preselected value PV from a device operator. The preselected value PV can be, for example, a desired flow rate or a desired magnetic flux. The measured signal can be, for example, a measured flow rate or a sensed magnetic flux as provide by a magnetic field sensor in the device.

The control circuit 200A can include a power source 220 that supplies a power to a magnetic field generator in response to a magnetic field set point signal received from the amplifier 210. For example, the control circuit 200A can implement a feedback loop to maintain the sensed magnetic field at a value selected by a valve operator. The power source 220 can be a current source and a magnetic field generator can be a coil.

As mentioned, a sensed magnetic field signal can be the measured signal MS to support a feedback loop to obtain a magnetic field in the solenoid that corresponds to a preselected value PV of the magnetic field. Alternatively, a measured signal MS provided by magnetic field sensor can support a correction to a selected solenoid current, and thereby effectively reduce hysteresis or other effects that limit the speed and accuracy of valve flow control.

In an alternative implementation of the control circuit 200A, the measured signal MS can be provided by a device parameter meter, such as a flow rate meter. The preselected value PV is then a desired parameter value, such as a desired flow rate value.

In this implementation, the magnetic field signal is directed to the power source 220. The operational amplifier 210 then compares the measured signal MS to the preselected value PV, for example, to compare a measured flow rate to a preselected flow rate; the operational amplifier 210 provides a magnetic field set point value to the current source 220. Thus, as described above for Step 370 of the method 300, the operational amplifier 210 updates the magnetic field set point value until the preselected value PV and measured signal MS have a desired correspondence. For each update of the magnetic set point value, the power source 220 updates the power delivered to the magnetic field generator to provide a correspondence between the magnetic field set point value and the sensed magnetic field.

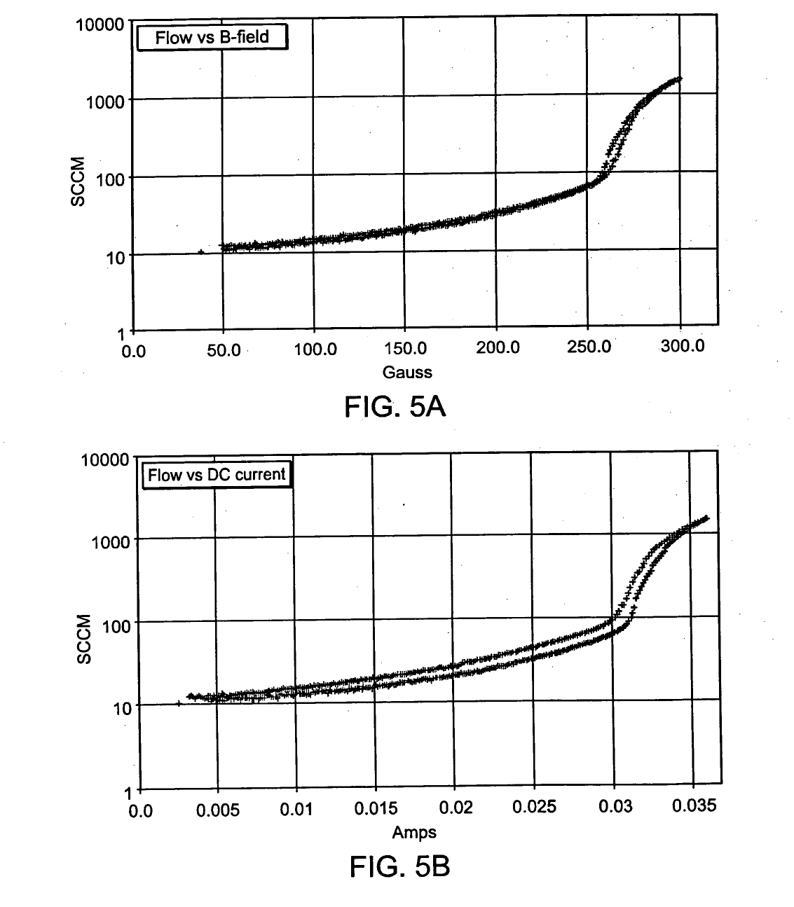

FIGS. 5A and 5B illustrate graphs of the flow rate of air through a sample valve assembled according to features of the invention illustrated by the devices 100, 100A. Flow rate data were collected as a function of applied electric current (see FIG. 5A) and measured magnetic field (FIG. 5B) for the sample valve. The graphs illustrate the reduction in hysteresis of a flow rate obtainable when flow is controlled via use of a sensed magnetic field signal as provided by a sensor in comparison to control via application of a selected electric current to a coil.

FIG. 5A illustrates the flow rate that is obtained as a function of current applied to the sample valve's coil. A significant amount of hysteresis appears in the flow rate curve. That is, significantly different flow rates are obtained as the current is cycled through identical current values.

In contrast, most of the hysteresis in the flow rate is eliminated when the valve is controlled by selecting a magnetic field sensed by a Hall-effect sensor. Thus, there is a tighter correlation between the force applied to the plunger and the sensed magnetic field than between the applied force and the applied current.

A mass flow control valve for semiconductor fabrication applications can be implemented according to principles of the invention described above. The valve can be implemented to control a variety of gases and to obtain a wide range of flow rates and pressures. For example, gas can be delivered at a pressure in a range of 0.001 Torr to 1000 Torr, and at a flow rate in a range from 0.001 sccm to 200 slm. The gas can include an inert gas, a reactive gas or a mixture of inert and reactive gases.

“Inert gases” are gases that in many circumstances are non-reactive or have low reaction rates, including argon and the other noble gases. “Noble gases” are a group of rare gases that include helium, neon, argon, krypton, xenon, and sometimes radon, and that exhibit chemical stability and low reaction rates. A “reactive gas” is a gas containing some species that are prone to engage in one or more chemical reactions. An “activated gas” includes any of ions, free radicals, neutral reactive atoms and molecules.

While the invention has been particularly shown and described with reference to specific preferred embodiments, it should be understood by those skilled in the art that various changes in form and detail may be made therein without departing from the spirit and scope of the invention as defined by the appended claims. For example, solenoid devices implemented according to principles of the invention can serve many applications, such as electromagnets, inductors in electronic circuits, receiving antennae, and switches.

What is claimed is:

1. A solenoid device, comprising:
a magnetic flux circuit member formed at least in part from a ferromagnetic material and defining a gap that is effectively free of a ferromagnetic bridge;
a magnetic field generator that generates a magnetic flux in a circuit comprising the magnetic flux circuit member and the gap; and
a magnetic flux sensor to sense a portion of the magnetic flux that extends across the gap.

2. The solenoid device of claim 1, wherein the magnetic flux circuit member comprises a housing and a plunger that is moveably mounted relative to the housing.

3. The solenoid device of claim 2, wherein the magnetic flux circuit member further comprises a backstop intersecting a direction of movement of the plunger, wherein two of the housing, the plunger, and the backstop are separated by the gap.

4. The solenoid device of claim 2, further comprising a valve seat that controls a fluid flow rate in cooperation with the plunger.

5. The solenoid device of claim 1, wherein the sensor is disposed in the gap.

6. The solenoid device of claim 1, wherein the gap is symmetrical, thereby providing a uniform magnetic flux in the gap.

7. The solenoid device of claim 1, wherein the gap has a uniform width.

8. The solenoid device of claim 1, wherein the gap defines a ring shape.

9. The solenoid device of claim 1, further comprising a material disposed in the gap and having a magnetic permeability that is lower than a magnetic permeability of the ferromagnetic material.

10. The solenoid device of claim 9, wherein the material disposed in the gap comprises at least one of a gas, a liquid, and a solid.

11. The solenoid device of claim 1, wherein the magnetic field generator comprises a coil.

12. The solenoid device of claim 1, further comprising a control circuit in electrical communication with the magnetic flux sensor and the magnetic field generator to maintain a selected value of the magnetic flux in the gap by controlling a signal applied to the magnetic field generator in response to the sensed portion of the magnetic flux.

13. The solenoid device of claim 1, wherein the solenoid device is a switch.

14. A solenoid device, comprising:
a magnetic flux circuit member formed at least in part from a ferromagnetic material and defining a gap that is effectively free of a ferromagnetic bridge;
means for inducing a magnetic flux in a circuit comprising the magnetic flux circuit member and the gap; and
means for sensing a portion of the magnetic flux that extends across the gap.

15. A method for operating a solenoid device, comprising:
providing a magnetic flux circuit member formed at least in part from a ferromagnetic material and defining a gap that is effectively free of a ferromagnetic bridge, and
inducing a magnetic flux in a circuit comprising the magnetic flux circuit member and the gap, thereby causing the magnetic flux to substantially extend through the magnetic flux circuit member and across the gap; and
sensing a portion of the magnetic flux that extends across the gap.

16. The method of claim 15, wherein inducing the magnetic flux comprises controlling a value of the magnetic flux that extends across the gap in response to the sensed portion of the magnetic flux to control a magnetic force applied to the plunger.

17. The method of claim 15, wherein a material disposed in the gap and has a magnetic permeability that is lower than a magnetic permeability of the magnetic flux circuit member.

18. The method of claim 15, wherein the magnetic flux circuit member comprises a plunger, and further comprising providing a valve seat that controls a fluid flow rate in cooperation with the plunger, and maintaining a value of the magnetic flux in the gap in response to the sensed portion of the magnetic flux to provide a value of the fluid flow rate associated with the value of the magnetic flux.

19. A method for operating a flow control valve, comprising:
comparing a measured flow rate of the valve to a preselected flow rate;
sensing a portion of a magnetic flux in a magnetic flux circuit of the valve; and
causing the sensed magnetic flux to change until the measured flow rate corresponds to the preselected flow rate.

20. The method of claim 19, wherein comparing the measured flow rate to the preselected flow rate comprises changing a magnetic field set point when the measured flow rate deviates from the preselected flow rate, and causing the sensed magnetic flux to change comprises causing the sensed magnetic flux to correspond to the magnetic field set point.
